(19) United States
(12) Patent Application Publication
(10) Pub. No.: US 2007/0044794 A1
(43) Pub. Date: Mar. 1, 2007

(54) Ventilation system for medical gases

(76) Inventors: Ivan Sabesky, Winnipeg (CA); Rita Korczynski, Winnipeg (CA); Mark Nepon, Winnipeg (CA)

Correspondence Address: Ade & Company Inc, 1795 Henderson Highway, PO Box 28006, Winnipeg Manitoba, R2G 4E9, CA

(21) Appl. No.: 10/578,668

(22) PCT Filed: Nov. 10, 2003
(86) PCT No.: PCT/CA03/01714

§ 371 Date: May 9, 2006

(51) Int. Cl. A62B 29/00

(52) U.S. Cl. 128/200.28

(57) ABSTRACT

A ventilation system (10) ventilates surrounding waste gases or bio-contaminants and the like exhaled from a patient or dissipated nearby in the vicinity of the face of the patient. The system generally comprises an envelope (20) having breathable surface portions (40) for collecting gases therethrough into a hollow interior (28) of the envelope. A suction port (30) coupled to the envelope collects the gases from the hollow interior for removal by a suction device (16). The use of an envelope having breathable surface portions which is at least partly flexible permits the system to be readily applied to a patient by simply placing the envelope under the head of the patient like a pillow.

### FIELD OF THE INVENTION

The present invention relates to the collection of gases, especially medical gases, and airborne contaminants, for example fumes, mists and particulates, from the vicinity of the face of a patient.

### BACKGROUND

In the application of anaesthetic or analgesic gases by means of a gas delivery mask to medical and dental patients, it is known for some gas to often escape into the surrounding environment. Also, when treating certain patients, waste gas or bio-contaminants exhaled by the patient or of concern to others in the surrounding area. It is known to be desirable to prevent accumulation of these gases or contaminants in the area immediately surrounding the patient by providing ventilation or means to collect the gases. Many known ventilation or collection devices however interfere with access to the patient's mouth making them unsuitable for certain applications, for example in dentistry.

U.S. Pat. No. 5,513,632 to Nepon et al and U.S. Pat. No. 4,895,172 to Lindkvist each disclose ventilation devices for collecting gases from an area surrounding a patient's face while providing some access to the patient's mouth. In general however these devices are cumbersome and awkward to apply to the face of the patient which results in discomfort of the patient while interfering with access to the patient by persons treating the patient.

### SUMMARY

According to the present invention there is provided a ventilation system comprising:

an envelope including a hollow interior and at least one breathable surface portion allowing gas to pass from a surrounding area of the envelope to the hollow interior through said at least one breathable surface portion of the envelope;

a suction port coupled to the envelope in communication with the hollow interior of the envelope; and

suction means for communication with the suction port for drawing gas from the surrounding area and into the suction port, through said at least one breathable surface portion of the envelope.

The use of an envelope having breathable portions therein permits the ventilation system to be easily stored and subsequently applied to a patient by simply placing the envelope under the head of the patient like a pillow. The collapsible nature of the envelope, when flexible, ensures the patient's comfort while providing complete access to the patient by persons treating the patient. The positioning of the breathable portions on the envelope permit the area from which gases are to be collected to be controlled for optimal collection.

The envelope preferably includes a pair of the breathable surface portions at spaced positions from one another wherein each breathable surface portion is elongate in a respective longitudinal direction lying substantially parallel to the longitudinal direction of the other breathable surface portion.

The breathable surface portions may be raised in relation to a central portion spanning therebetween which is flexible for supporting the head of a patient thereon.

A support structure preferably supports the breathable surface portions raised above a bottom side of the envelope.

The breathable surface portions are preferably located only in an upper side of the envelope when the envelope includes an outer shell substantially impermeable to gas particles and the breathable surface portions span respective openings in the outer shell. Both the outer shell and the breathable surface portions are preferably formed of pliable material.

When the envelope includes a pair of breathable surface portions at spaced positions from one another on opposing sides of a central portion, the central portion is preferably suitably sized for supporting a head of a person thereon. A support structure is provided for supporting the central portion suspended above a bottom side of the envelope.

For hygienic purposes, there may be provided a selectively separable cover supported on an upper side of the envelope, spanning between the breathable surface portions which are commonly located in the upper side of the envelope.

When the support structure comprises an internal support structure, it is preferably surrounded by the envelope and supports upper and lower sides of the envelope spaced from one another spanning between the suction port and said at least one breathable surface portion. The envelope in this instance may be fully or only partially formed of flexible material.

When the internal support structure is generally U-shaped to include a base portion and two side portions, one of said at least one breathable surface portions is located at each of the side portions and the suction port is located at the base portion.

Alternatively, the support structure may comprise stiff material integrally formed with the envelope. In this instance, a bottom side and a pair of opposed upright side walls of the envelope are formed of said stiff material, while the upper portion of the envelope is flexible and spans the upright side walls. One of the breathable surface portions is located adjacent each of the upright side walls.

### BRIEF DESCRIPTION OF THE DRAWINGS

In the accompanying drawings, which illustrate exemplary embodiments of the present invention:

FIG. 1 is an isometric view of the ventilation system shown supporting the head of a patient thereon;

FIG. 2 is a top plan view of a first embodiment of the system;

FIG. 3 is a sectional view of the system along the line 3-3 of FIG. 2 in a relaxed position of the system;

FIG. 4 is a similar sectional view along the line 3-3 of FIG. 2 in a flexed position of the system;

FIG. 5 is a sectional view along the line 5-5 of FIG. 2;

FIG. 6 is a top plan view of a second embodiment of the system; and

FIG. 7 is a sectional view along the line 7-7 of FIG. 6.

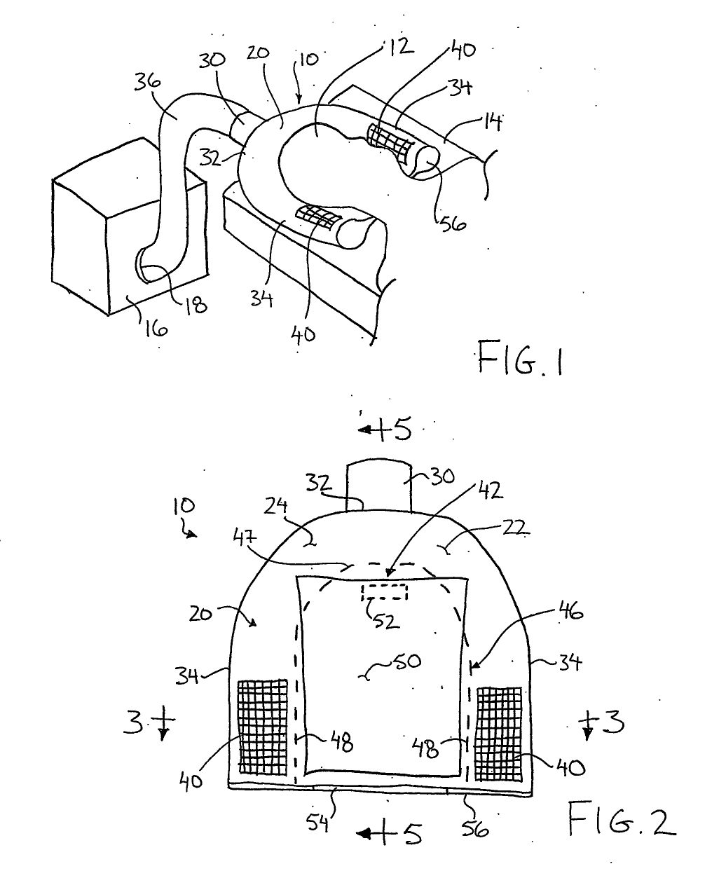

### DETAILED DESCRIPTION

Referring to the accompanying drawings, there is illustrated a ventilation system generally indicated by reference numeral 10. The system 10 is particularly useful for collecting waste gases or bio-contaminants and the like, exhaled by a patient or dissipated in the vicinity of the head 12 of the patient lying on a supporting surface 14, for example a patient's chair or a stretcher. Using the system 10, gases are collected by a suction device 16, for example a collector or an exhaust fan which may vent the collected gases to atmosphere or to a filter system. Waste gases or contaminants may include anaesthetic gases used on the patient or bio-contaminants either dissipated in the vicinity of the face of the patient or which are exhaled by the patient.

While the illustrated embodiment of the system is particularly suited for supporting the head of a person thereon, the system may be used in veterinary applications for supporting the head of an animal thereon when the patient comprises an animal. In further embodiments, the particular size and shape may be modified so as to be particularly suited for certain types of animals.

While various embodiments are described herein, the common features will first be described herein. The system 10 generally includes an envelope 20 having an outer shell 22 formed of material which is impermeable to gas. The outer shell includes an upper surface 24 and a lower surface 26 which are broad and generally flat in a normal relaxed position of the system. The upper and lower surfaces 24 and 26 bound a hollow interior 28 of the envelope.

A suction port 30 is connected to the envelope at a top end 32 of the system. The suction port generally comprises a tube in communication with the hollow interior 28 of the system. The suction port 30 is laterally centered between opposed side edges 34 of the envelope. Tubing 36 connects the suction port 30 to the inlet 18 of the suction device 16 so that gases drawn into the hollow interior of the envelope are subsequently sucked through the suction port and into the suction device 16.

A pair of breathable surface portions 40 are supported to span openings in the surrounding upper surface 24 of the envelope. Each breathable surface portion comprises a flexible mesh which permits gas to be passed therethrough from the surrounding area of the envelope to the hollow interior of the envelope. The two breathable surface portions are elongate and extend in respective longitudinal directions along the opposite side edges 34 of the envelope so as to be spaced apart and parallel to one another as well as the side edges 34.

A flexible central portion 42, which is suitably sized to support the head 12 of the patient thereon, spans between the pair of breathable surface portions 40 of the envelope. When the head of a person is supported on the central portion 42, the breathable surface portions 40 are suitably sized to extend from the chin to the cheek bone, or even the temple of the face of the person, on opposite sides of the face. Locating the breathable surface portions in a top side of the envelope ensures that the air containing gases or airborne contaminants surrounding the face of the patient are drawn downwardly into the envelope in a downdraft configuration away from persons treating the patient, as opposed to drawing air upwardly towards persons treating the patient as occurs in many conventional ventilation devices when the ventilation devices are supported above the patient.

A support structure 46 is provided which supports the upper side of the envelope spaced above the bottom side of the envelope between the suction port and both breathable surface portions of the envelope to permit passage of air and gas through the envelope. The support structure also suspends the central portion 42 of the envelope to comfortably float the head of a person thereon.

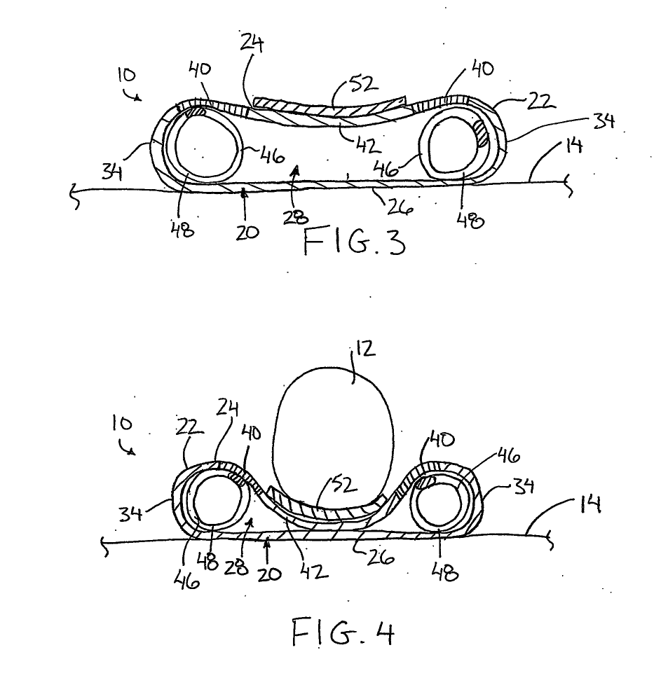

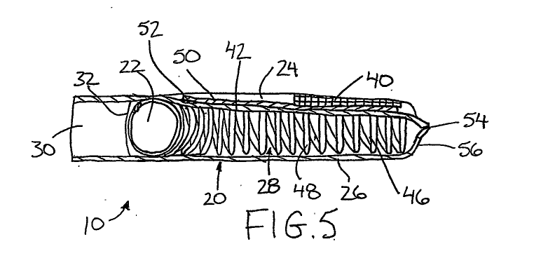

In a relaxed position, shown best in FIG. 3 and FIG. 7, the upper surface 24 of the envelope spans above the lower surface 26 in a manner so that both breathable surface portions 40 face generally upwardly from a common upper side of the envelope. Applying the weight of the head of the patient to the central portion 42 however collapses the central portion into the flexed position, shown in FIG. 4. In the flexed position, the central portion of the upper surface 24 of the envelope is collapsed downwardly towards the lower surface 26 of the envelope which pulls the breathable surface portions 40 downwardly and inwardly towards one another so as to slightly rotate the breathable surface portions 40 about the respective side portions of the support structure 46. In the flexed position, the breathable surface portions 40 thus partially confront one another so as to face upwardly and slightly inwardly towards one another so as to be suitably positioned for confronting opposing sides of the face of the patient.

Turning now more specifically to the first embodiment, the support structure 46 comprises an internal support structure about which an envelope, fully formed of flexible material, surrounds. The support structure 46 is internally supported within the hollow interior of the envelope between the upper and lower surfaces so as to maintain the upper surface 24 spaced above the lower surface 26 about a periphery of the envelope to form a common area spanning the suction port and both breathable portions. The internal support structure generally comprises a coil of wire which forms a tubular channel extending in a generally U-shaped configuration about the resilient central portion 42 so as to span in communication between the breathable surface portions 40 while being intersected by the suction portion 30 at the top end thereof. The suction port thus communicates with a base portion 47 of the internal support structure which extends between opposed side portions 48 of the U-shaped structure. Each of the side portions 48 communicates with a respective one of the breathable surface portions 40 at an end thereof so that the support structure 46 spans between the suction port and both breathable surface portions 40.

The side portions 48 of the support structure 46 support the breathable surface portions in the upper surface of the envelope in a raised position above the resilient central portion 42 spanning between opposing side portions of the internal support structure. The coil of wire forming the support structure is flexed into the U-shaped configuration so that the central portion 42 of the upper surface of the envelope is supported under tension spanning between the breathable surface portions 40.

A cover 50 is provided in the form of a pliable sheet of felt or padded material which is suitably sized to span the resilient central portion 42 without obstructing the breathable surface portions 40. The cover 50 is selectively separable from the central portion 42 by respective hook and loop fasteners which secure the cover to the envelope.

A slotted opening 54 is provided along a bottom end 56 of the envelope extending between the ends of the side portions 48 of the support structure 46. The opening 54 includes a closure mechanism for sealing the opening closed, for example hook and loop fasteners, or other suitable means for effecting an air tight seal may be preferred.

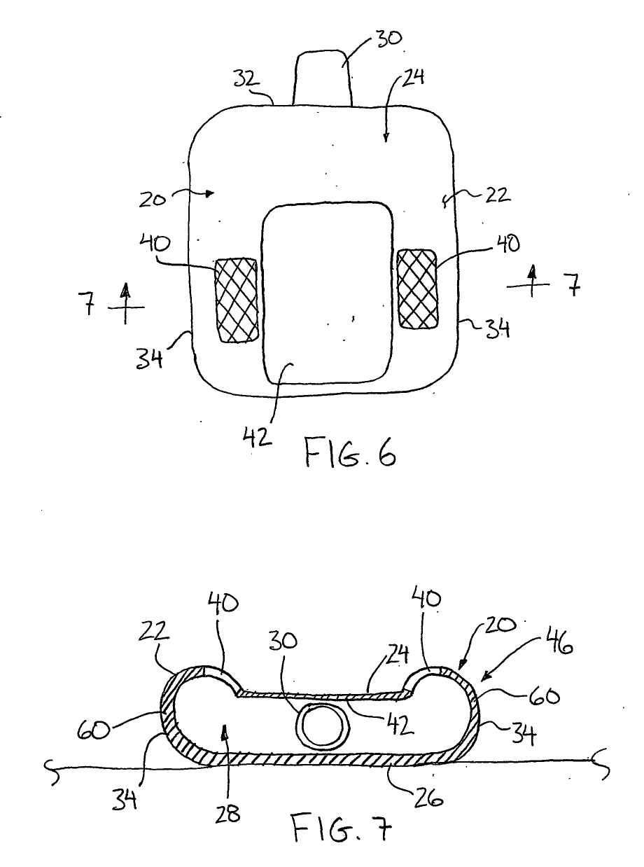

Turning now to FIGS. 6 and 7, a second embodiment of the ventilation system is illustrated in which the support structure 46 is formed integrally with the envelope 20. More specifically, the envelope 20 is moulded as a single piece having varying material properties, for example varying thickness to vary the flexibility throughout. In this embodiment the bottom surface 26 and opposing side edges 34 are all integrally formed of a material of suitable thickness so as to be stiff and somewhat rigid. The central portion 42 is flexible and forms a portion of the upper surface 24 spanning between opposing upright side walls 60 forming the side edges 34 of the envelope. The upright side walls 60 each curve upwardly and inwardly towards one another for locating the pair of breathable surface portions 40 respectively therein to partially confront one another and partially face upward.

The side walls.60 and the lower surface 26 have a suitable rigidity so as to support the head of a person resting on the flexible central portion 42 which spans under tension between the uprights side walls 60. While the opposing side walls 60 locating each of the breathable surface portions directly adjacent thereto are rigid, the top end 32 spanning therebetween maybe either flexible or rigid and simply acts to locate the suction port 30 therein. Opposite the suction port 30 at the bottom end, the edge of the envelope joining the upper and lower surfaces remains flexible and unrestricted so as not to cause any discomfort to a person lying down when the head of the person is received therethrough between the breathable surface portions 40. As described above when a person places their head on the flexible central portion 42, the central portion conforms comfortably to the shape of the persons head while causing the upright side walls 60 to flex inwardly slightly so that the breathable surface portions 40 rotate slightly inwardly to further-confront one another directly along side opposing cheeks of the person whose head is being supported on the envelope.

While some embodiments of the present invention have been described in the foregoing, it is to be understood that other embodiments are possible within the scope of the invention. The invention is to be considered limited solely by the scope of the appended claims.

1. A ventilation system comprising:
an envelope including a hollow interior and at least one breathable surface portion allowing gas to pass from a surrounding area of the envelope to the hollow interior through said at least one breathable surface portion of the envelope;
a suction port coupled to the envelope in communication with the hollow interior of the envelope; and
suction means for communication with the suction port for drawing gas from the surrounding area and into the suction port, through said at least one breathable surface portion of the envelope.

2. The system according to claim 1 wherein the envelope includes a pair of the breathable surface portions at spaced positions from one another.

3. The system according to claim 2 wherein each breathable surface portion is elongate in a respective longitudinal direction lying substantially parallel to the longitudinal direction of the other breathable surface portion.

4. The system according to claim 2 wherein the breathable surface portions are raised in relation to a central portion spanning therebetween which is flexible.

5. The system according to claim 2 wherein there is provided a support structure supporting the breathable surface portions raised above a bottom side of the envelope.

6. The system according to claim 1 wherein said at least one breathable surface portion is located only in an upper side of the envelope.

7. The system according to claim 1 wherein the envelope includes an outer shell substantially impermeable to gas particles, said at least one breathable surface portion spanning an opening in the outer shell.

8. The system according to claim 7 wherein both the outer shell and said at least one breathable surface portion are formed of pliable material.

9. The system according to claim 1 wherein the envelope includes a pair of breathable surface portions at spaced positions from one another,on opposing sides of a central portion, the central portion being suitably sized for supporting a head of a person thereon.

10. The system according to claim 9 wherein there is provided a support structure supporting the central portion suspended above a bottom side of the envelope.

11. The system according to claim 9 wherein there is provided a selectively separable cover supported on an upper side of the envelope, spanning between the breathable surface portions which are commonly located in the upper side of the envelope.

12. The system according to claim 1 wherein there is provided a support structure supporting an upper side of the envelope spaced above a lower side of the envelope.

13. The system according to claim 12 wherein at least a portion of the upper side of the envelope is flexible.

14. The system according to claim 12 wherein the support structure comprises an internal support structure surrounded by the envelope which supports upper and lower sides of the envelope spaced from one another spanning between the suction port and said at least one breathable surface portion.

15. The system according to claim 14 wherein the envelope is fully flexible.

16. The system according to claim 14 wherein the internal support structure is generally U-shaped to include a base portion and two side portions, one of said at least one breathable surface portions being located at each of the side portions and the suction port being located at the base portion.

17. The system according to claim 12 wherein the support structure comprises stiff material integrally formed with the envelope.

18. The system according to claim 17 wherein a bottom side and a pair of opposed upright side walls of the envelope are formed of said stiff material.

19. The system according to claim 18 wherein the upper portion of the envelope is flexible and spans the upright side walls.

20. The system according to claim 18 wherein there is provided one of said at least one breathable surface portions adjacent each of the upright side walls.
